(19) United States
(12) Patent Application Publication
(10) Pub. No.: US 2026/0154684 A1
(43) Pub. Date: Jun. 4, 2026

(54) DETECTION OF COMPROMISED HARDWARE SYSTEMS USING SETS OF ACCOUNT NUMBERS

(71) Applicant: TOSHIBA GLOBAL COMMERCE SOLUTIONS, INC., Durham, NC (US)

(72) Inventors: James I. HAWK, Morrisville, NC (US); Columbus L. BROWN, II, Wake Forest, NC (US)

(21) Appl. No.: 18/969,050

(22) Filed: Dec. 4, 2024

(51) Int. Cl. G06Q 20/40; G06Q 20/18

(52) U.S. Cl. CPC G06Q 20/401; G06Q 20/18

(57) ABSTRACT

Embodiments herein describe storing in hardware systems different combinations of financial account numbers which are set up to identify when a particular hardware system has been compromised. If compromised, a nefarious actor can identify the financial account numbers and believe they are real (e.g., customer) account numbers. Once a nefarious actor, e.g., uses the account number to attempt to purchase an item, the financial institution issuing the account numbers notifies the manufacturer or owner of the hardware system. By assigning different, unique combinations of the account numbers to different hardware systems, the manufacturer or owner can identify the specific system that was comprised, without having to store a unique account number in each hardware system.

### BACKGROUND

Retail point of sale (POS) is a lucrative target for malicious or nefarious actors (e.g., hackers). As an example, a nefarious actor can install malware on a POS system (or other hardware system that is part of a payment network) to look for unencrypted credit card numbers in the memory of the POS system. Once a malicious actor gains access to the data stored in the POS system, it is referred to herein as being compromised. Identifying a compromised POS system can be time consuming and can cause significant financial impacts to the retailer (and shoppers if their personal information is stolen).

### BRIEF DESCRIPTION OF THE DRAWINGS

FIG. 1 illustrates a POS system, according to embodiments described herein.

FIG. 2 is a system for identifying a compromised POS system, according to embodiments described herein.

FIG. 3 is a flowchart for storing unique sets of financial account numbers in POS systems, according to embodiments described herein.

FIG. 4 is a flowchart for identifying a compromised POS system, according to embodiments described herein.

FIG. 5 is a flowchart for identifying a compromised hardware system according to embodiments described herein.

### DETAILED DESCRIPTION

Embodiments herein describe storing in POS systems different combinations (or sets) of “planted” financial account numbers (e.g., credit card numbers, gift card numbers, etc.) which are set up to identify when a POS system has been compromised. If compromised, a nefarious actor can discover the planted financial account numbers stored in memory in the POS system and mistakenly believe they are real (e.g., customer) account numbers. Once a nefarious actor uses the planted account number to purchase an item, the financial institution issuing the account numbers notifies the POS system manufacture or owner. By assigning different, unique combinations of the account numbers to different POS system, the manufacture or owner can identify the specific POS system that was comprised, without having to store a unique account number in each hardware system. That is, many different unique sets of planted account numbers can be created using a limited set of account numbers, which permits each POS system to get a unique set of account numbers without having to open a separate financial account for each system.

In another embodiment, the same combination of planted account numbers could be assigned to multiple hardware systems. For example, the POS systems in the same store (or same region) may be given the same combination of account numbers. Or the hardware devices in the same layer (or same type of node) in a network may be given the same combination of account numbers. For example, the POS systems may have the same combination of account numbers, while store network equipment store a different combination of account numbers, and payment servers store a different combination of account numbers. This reduces the number of account numbers needed, and also provides insight into where in a software stack or a network a breech has occurred.

### Advantages of Storing Combinations of Financial Account Numbers in Hardware Systems

Storing different (or unique) combinations of account numbers in different hardware systems, such as POS systems, payment servers, clearing houses, network equipment, etc., enables quick remediation such as deactivating affected hardware systems, identifying the attack vector, and/or isolating the compromised hardware systems from systems that are not compromised. This can provide technical benefits such as improving data security and reducing network downtime.

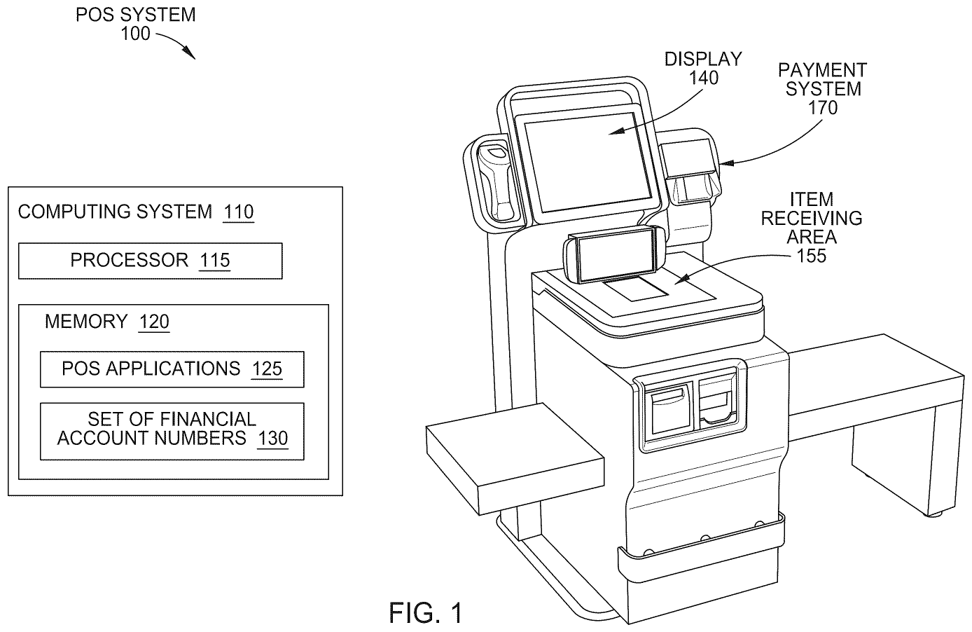

FIG. 1 illustrates a POS system 100, according to embodiments described herein. The POS system 100 includes a computing system 110 with a processor 115 and memory 120. In one embodiment, the computing system 110 is an all-in-one (AIO) computer where each component of the computing system 110 is disposed within the POS system 100. The processor 115 can represent one or more processing elements, where each processing element can include one or more processing cores. The memory 120 can include volatile memory elements, non-volatile memory elements, and combinations thereof. Here, the memory stores POS applications 125 (e.g., software applications) which can include an image recognition application that uses images captured by cameras to identify an item for purchase using a computer vision algorithm (e.g., an artificial intelligence (AI) or machine learning (ML) model), an item lookup application to identify items for purchase from scanning bar codes or RFID tags, user interaction applications for displaying items for purchase and receiving user feedback, and the like.

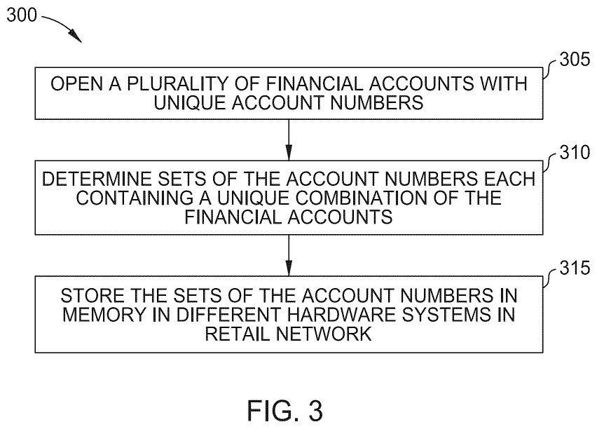

The memory 120 also stores a set of financial account numbers 130. In one embodiment, the set of account numbers 130 is unique to the POS system 100. However, in other embodiments, the same set of account numbers 130 may be stored on multiple POS systems (e.g., the POS systems in the same store or in the same region). Different techniques for assigning the set of account numbers 130 will be discussed in FIG. 3 below.

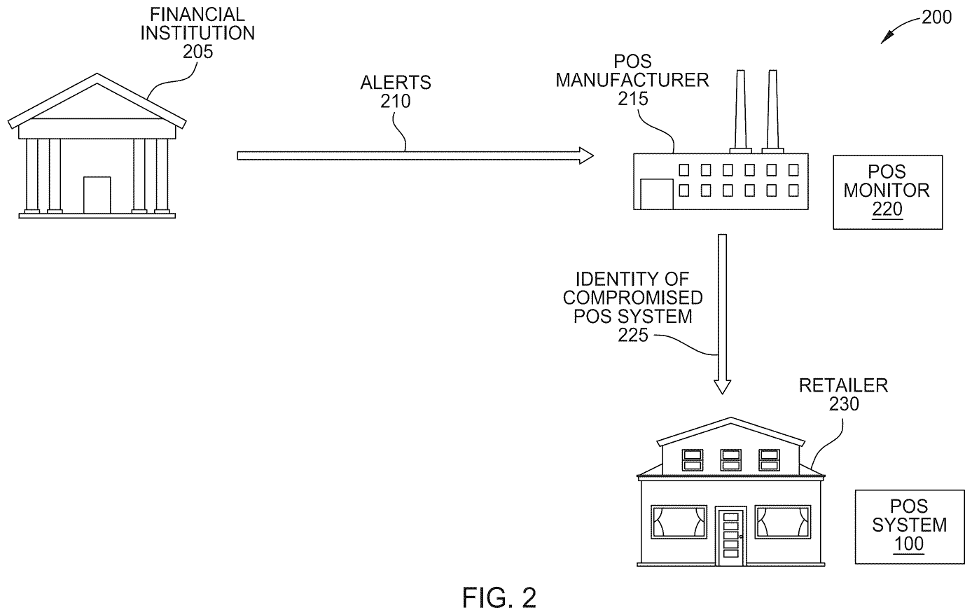

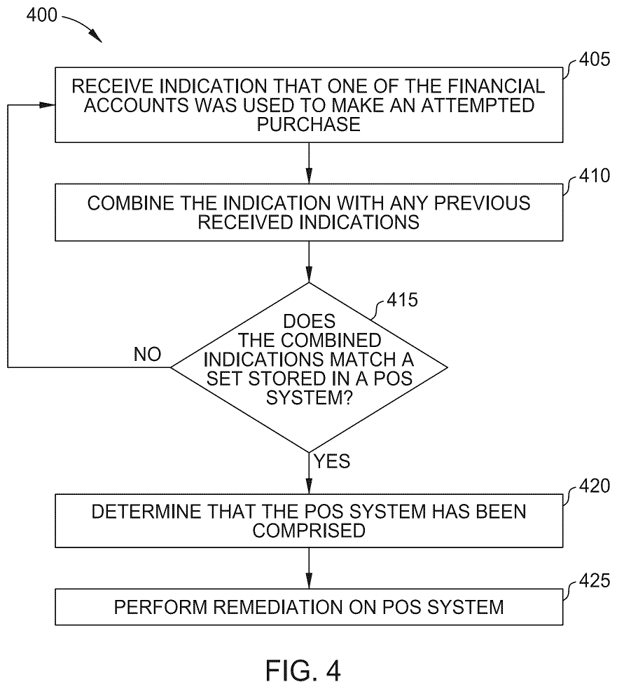

In one embodiment, the set of financial account numbers 130 are used as bait or a “plant” to determine when the POS system 100 has been compromised. For example, if a nefarious actor gains access to the memory 120 using, e.g., malware, the malware may scan the memory for account numbers (e.g., primary account numbers (PANs), credit card numbers, bank account numbers, gift card numbers, etc.). Malware will discover the set of financial account numbers 130 and assume they are real account numbers (e.g., the account numbers associated with customers who use the POS system 100). Once a nefarious actor uses the set of financial account numbers 130 to make a purchase, the financial institution can notify the owner (or manufacturer) of the POS system. This enables the owner to identify the POS system 100 as being compromised. This is discussed in more detail in FIGS. 2 and 4 below.

In one embodiment, the set of financial account numbers 130 are stored in main memory of the computing system 110 (e.g., RAM). Because the main memory may be volatile memory (where the data stored is lost when powered off), one of the POS applications 125 may store the set of account numbers 130 back in the main memory when the POS system 100 is powered back on. Putting the set of account numbers 130 in the main memory may be advantageous since it makes them easy to find, and thus likely they will be discovered (and used) by a nefarious actor.

In one embodiment, the set of account numbers 130 are stored in memory associated with a payment application, or stored in a log that logs financial transactions for the POS system 100. This may be non-volatile memory. Doing so may be more convincing to a nefarious actor that the account numbers 130 are real since they are stored in a memory location that stores actual, real customer numbers. In one embodiment, the set of account numbers 130 can be stored in a fake log that may be labeled to indicate it is used during financial transactions.

In yet another embodiment, the computing system 110, at intervals, stores and deletes the set of account numbers 130. When handling real account numbers, the computing system 110 may store the applications in memory temporary before they are deleted (e.g., when the transaction is complete). The computing system 110 can mimic this behavior with the set of account numbers 130 where the numbers are stored in any of the memory locations discussed above for a predefined time period (which may correspond to the usual time that real account numbers are stored in memory in an unencrypted state) and then delete the numbers. After waiting a time period, the computing system can repeat the process and again store the set of account numbers 130 in memory before deleting them. As such, this may convince the nefarious actors the set of account numbers 130 are customer account numbers and use them so their actions are detected.

The display 140 can display information to the customer such as the identity of the item detected by the POS applications 125, a list of items already purchased, cost of the items, etc. The display 140 could be a touch screen for user interaction, or may not have touch capabilities. If the display 140 is a touch screen, it can serve as an input/output (IO) device for receiving customer input.

Although not shown, the POS system 100 can also include one or more cameras 135 disposed to view an item-receiving area 155 in the base 150 on which the shopper places items for purchase. For example, a camera may disposed in a downward direction. Moreover, to improve the ability to successful identify an item, cameras may also be disposed on the sides of the POS system 100.

The item-receiving area 155 defines an area where a customer can place an item for purchase so it can be identified by, for example, scanning a barcode, reading an RFID tag, capturing images of the item and using an the item recognition application, and the like. In one embodiment, the item-receiving area 155 can include a weight sensor (e.g., a scale) or pressure sensors to identify an outline of the item, but this is not a requirement.

The payment system 170 can include a credit card reader, chip reader, near field communication (NFC) reader, coin/currency machine, and the like.

In one embodiment, the POS system 100 is a self-service POS system (or self-service kiosk). However, in other embodiments the POS system 100 may be a cashier operated POS system. Further, as discussed in more detail below, using the set of financial account numbers 130 to detect whether the POS system 100 is compromised can be used with other hardware system, such as payment servers, network equipment, and the like.

FIG. 2 is a system 200 for identifying a compromised POS system, according to embodiments described herein. The system 200 includes a financial institution 205 which provides financial account numbers, the POS manufacturer 215 that stores the sets of financial account numbers in the POS systems 100, and the retailer who deploys the POS systems 100 in their stores.

When one of the financial account numbers is used to make a purchase (e.g., the POS system 100 has been compromised), the financial institution 205 transmits an alert to the POS manufacturer 215. The financial institution 205 can be a bank, credit card company, gift card provider, etc.

In another embodiment, rather than the financial institution 205 transmitting the alert, the alert 210 can be generated in response to a search on, e.g., the dark web, which discovers one of the financial account numbers stored in the POS system 100. Thus, the alert 210 can be generated by other detection techniques besides one of the account numbers being used to make a purchase.

The POS manufacturer 215 can execute a POS monitor 220 (e.g., a software application executing on a computing system) which receives the alerts 210 from the financial institution 205 and uses the account numbers in the alerts 210 to identify a compromised POS system 100. For example, the financial institution 205 can send alerts 210 for multiple account numbers used to make multiple purchases. The POS monitor 220 can determine which POS systems 100 store a set of account numbers that matches the account numbers in the alert 210. This is discussed more in FIG. 4.

As shown by the arrow 225, the POS manufacturer 215 can inform the retailer 230 of the identity of any POS systems 100 that have been compromised. Knowing the identity of the compromised POS system 100 permits the POS manufacturer 215 (assuming it provides the software for the POS system 100) to generate a software patch or provide instructions to the retailer 230 how to fix the breech. The speed at which the POS manufacturer 215 can perform remediation is greatly increased because it knows the identity of the comprised POS system, rather than having to identify which hardware system has been compromised.

The retailer 230 can also perform remediation, such as isolating the compromised POS system 100, or generating a patch to fix a vulnerability.

While FIG. 2 illustrates the alerts 210 going to the POS manufacturer 215, in other embodiment, the alerts 210 may instead be sent to the retailer 230, or to both the POS manufacturer 215 and the retailer 230. In that case, the retailer 230 may identify the compromised POS system 100.

FIG. 3 is a flowchart of a method 300 for storing unique sets of financial account numbers in POS systems, according to embodiments described herein. In this example, the method 300 is performed by the POS manufacturer. However, in other examples, the method 300 may be performed by a retailer after it has purchased a POS system from the manufacturer.

At block 305, the POS manufacturer opens a plurality of financial accounts with unique account numbers. The unique numbers can be PANS, gift card account numbers, bank account numbers, and the like.

At block 310, the POS manufacturer determines sets of the account numbers each containing a unique combination of the account numbers. Doing so can greatly reduce the amount of financial accounts that have to be opened. For example, while a different account number could be stored on each POS system, a POS manufacturer may sell hundreds or thousands of POS systems, which would require opening a different financial account for each POS system (i.e., opening thousands of financial accounts). Instead, a POS manufacturer may open, e.g., 40 financial accounts with 40 unique account numbers (with very small credit limits—e.g., $10 or less). These 40 account numbers can be grouped into 657,802 different (i.e., unique or orthogonal) sets of 5 account numbers. That is, the POS manufacturer can uniquely identify up to 657,802 different POS systems using these sets of 5 account numbers. Thus, with relatively few account numbers, the POS manufacturer can uniquely identify many POS systems.

At block 315, the POS manufacturer stores the sets of the financial account numbers in memory in different hardware systems in a retail network. In one embodiment, the sets are stored in POS systems so that each POS system has a different set or combination of account numbers. Thus, if each one of the account numbers in a set is used by a nefarious actor, the POS manufacturer knows the POS system was compromised.

In addition to storing the sets in POS systems, a retailer can store the sets in other hardware systems in a payment network, such as network equipment (e.g., switches/routers), payment servers, computing systems used by clearing houses, and the like. That way, the system can detect compromised hardware systems at different nodes or levels in a payment network. For example, a nefarious actor may gain access to only one node, or only one type of hardware device in the retail network. Since this can be quickly identified using the techniques described herein, the retailer network can minimize the harm and perform remediation faster.

In another embodiment, the same set of account numbers may be stored in multiple hardware systems. For example, the same set of account numbers may be stored in each POS system in a store while a different set is stored in each POS system in a different store. In this case, the retailer may assume that if one POS system in a store is compromised, they are all considered compromised. It also reduces the amount of unique account numbers that are used.

In another example, each type of hardware system in a payment network may be assigned the same set of account numbers. For example, each POS system for a retailer may store one set of account numbers, each network device may store another set of account numbers, and each payment server may store another set of account numbers. Again, the retailer may assume that if one type of hardware system in a payment network is compromised, they are all compromised. This also can reduce the amount of account numbers that are used, but still provide an indicator where in a network (or software stack) a breech has occurred.

In one embodiment, the method 300 is performed after the POS systems have been installed at the retailer. For example, the account numbers can be stored in the POS systems as part of a software update or when being configured/set up in the store.

In one embodiment, the sets of account numbers are swapped out at intervals. That is, the POS manufacturer or retailer may replace the sets of account numbers each week, month, etc. to provide time information when a POS system is compromised. For example, if the retailer has 100 POS system, it may replace the 100 sets of account numbers stored in those POS systems each month with 100 different sets of account numbers (where each one of the new sets is different from the previous sets). That way, when one set of account numbers is detected, this informs the POS manufacturer/retailer not only which POS system was comprised but also when it was compromised (e.g., within a specific week or month when that set of account numbers was stored in the particular POS system).

FIG. 4 is a flowchart of a method 400 for identifying a compromised POS system, according to embodiments described herein. The method 400 can be performed by a POS manufacturer (as shown in FIG. 2) or by a retailer. That is, the POS manufacturer or a retailer can include a POS monitor (e.g., the POS monitor 220 in FIG. 2) which performs method 400.

At block 405, the POS monitor receives an indication that one of the financial accounts was used to make (or attempt to make) a purchase. That is, a nefarious actor may have compromised a POS system (or other hardware system in a payment network) and found one of the account numbers that was stored (i.e., planted) in the POS system. This account number was then used by the nefarious actor (or someone who bought the account number from the nefarious actor) to make an attempted purchase (which may or may not be denied by the financial institution).

Alternatively, the POS monitor (or some other service) may search the dark web to look for the accounts numbers that were stored/planted in the POS systems. As such, the embodiments herein are not limited to any particular method for providing an indication when a nefarious actor has found an account number planted in the POS systems.

At block 410, the POS monitor combines the indication with any previous received indications. For example, the POS monitor may receive alerts over a period of time as different account numbers are used to make purchases (or found on the dark web). The POS monitor can maintain a list that includes each account number that has been used by a nefarious actor.

At block 415, the POS monitor determines whether the combined indications match a set of account numbers stored in a POS system. For example, the POS monitor may have only been notified of four account numbers but each POS system stores a set of five account numbers. As such, at this point in time, the POS monitor is unsure which specific POS system has been compromised. As such, the method 400 can return to block 405 to wait for an indication of other financial accounts that were used to make a purchase.

However, even if a match has not yet been made, the POS monitor may still inform the POS manufacturer or retailer that there has been a breech and begin performing remediation. For example, having four of the five account numbers may still narrow down the number of POS systems (or other hardware systems that have been compromised). Having some of the account numbers may be enough information for the retailer to rule out certain hardware devices as being compromised. For example, the retailer may not consider any hardware system that has a set of account numbers that does not include any of the four account numbers as being compromised. Thus, remediation can be performed on the subset of the hardware systems, before a particular (or specific) POS system has been identified.

In another example, it may be that only POS systems have those four account numbers in their sets, while no payment server has those four account numbers in their sets. In that case, the retailer can rule out the payment servers as being a source of the breech. This can help the retailer to respond quickly to the breech even though they do not yet know which particular one of the POS systems has been comprised.

As another example, the account numbers may be assigned so that certain account numbers are used in specific regions but not others. Thus, if the four account numbers include one of these “region specific” account numbers, the retailer knows the corresponding region has compromised POS systems while other regions may not have been compromised. This scheme could also be applied to different types of hardware systems in the network where each POS system stores at least one common account number (that is not used in the sets for any other types of hardware system), each payment servers stores at least one common account number (that is not used in the sets for any other types of hardware system), and so forth. That way, if one of these common account numbers is used to make a purchase, the retailer can know the breech occurred at one type of hardware system, but the other types of hardware systems have not been compromised (assuming their common account numbers were not used to make a purchase).

Thus, in these examples, the POS monitor can begin some remediation before identifying a match. Put differently, by identifying at least one of the planted financial accounts has been used by a nefarious action, the retailer may be able to narrow down the source of the breech and start remediation such as preparing a software patch, isolating the hardware systems, etc.

However, if at block 415 the POS monitor determines the combined indications do match a set of account numbers stored in a POS system, the method 400 proceeds to block 420 where the POS monitor determines that the corresponding POS system has been compromised. For example, if the POS monitor is being executed by the POS manufacturer, the manufacturer may alert the retailer that owns the POS system.

At block 425, the POS manufacturer and/or retailer perform remediation on the POS system. This can include turning off the POS system, installing a software patch (once the problem is identified), resetting the POS system, and the like.

Moreover, the method 400 can repeat as additional account numbers are reported to the POS monitor at block 405. The POS monitor can then identify additional POS systems that are comprised as more matches are identified at block 415.

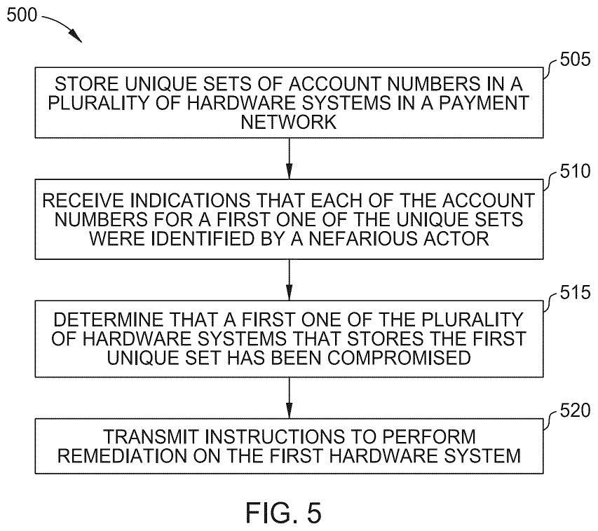

FIG. 5 is a flowchart of a method 500 for identifying a compromised hardware system. At block 505, a manufacturer or retailer stores unique sets of account numbers in a plurality of hardware systems in a payment network where each of the account numbers corresponds to a separate financial account. In one embodiment, each of the unique sets includes account numbers that are in other ones of the unique sets, but none of the unique sets have the same combination of account numbers. Moreover, the unique sets can be stored according to any of the embodiments discussed above in FIG. 3.

Moreover, the hardware system can be any hardware system in a payment network. Examples can include POS systems, network equipment (e.g., routers/switches), payment servers, and the like. In one embodiment, the payment network is established by a retailer with physical stores, but the embodiments herein could be used by a retailer without physical stores (e.g., online marketplaces) which would not include physical POS systems.

At block 510, the POS monitor receives indications that each of the account numbers for a first one of the unique sets were identified by a nefarious actor. That is, the POS monitor determines there is a match between the account numbers that have been accessed by a nefarious actor and one of the unique sets stored in the plurality of hardware systems.

At block 515, the POS monitor determines that a first one of the plurality of hardware systems that stores the first unique set has been compromised.

At block 520, the POS monitor transmits instructions to perform remediation on the first hardware system. This can include a manufacturer that alerts the retailer that the first hardware system has been compromised, and the retailer performs remediation based on that information. If the POS monitor is executed by the retailer, at block 520 the retailer can instruct its IT department or a third-party security provider to perform remediation.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to the described embodiments. Instead, any combination of the features and elements described herein, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages discussed above are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the POS monitor 220 in FIG. 2) or related data available in the cloud. For example, the POS monitor could execute on a computing system in the cloud, receive alerts when the planted account numbers are used, and identify compromised hardware systems. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

1. A method comprising:
storing unique sets of account numbers in a plurality of hardware systems in a payment network, wherein each of the account numbers corresponds to a separate financial account;
determining that an account number for a first one of the unique set of account numbers stored in at least one of the plurality of hardware systems in the payment network is compromised;
receiving indications that each of the account numbers for the first one of the unique sets are compromised;
identifying a first one of the plurality of hardware systems in the payment network that comprises the compromised first one of the unique set of account numbers; and
causing a remediation operation to perform on the first one of the plurality of hardware systems in the payment network that comprises the compromised first one of the unique set of account numbers, wherein the remediation operation comprises:
isolating the first one of the plurality of hardware system from the remaining plurality of hardware systems in the payment network and deactivating the isolated first one of the plurality hardware systems from the payment network.

2. The method of claim 1, wherein each of the unique sets includes account numbers that are in other ones of the unique sets, but none of the unique sets have the same combination of account numbers.

3. The method of claim 1, further comprising:
receiving alerts from a financial institution that the account numbers have been used to make attempted purchases.

4. The method of claim 1, wherein the unique sets of account numbers are planted in memories of the plurality of hardware systems and are intended to be discovered when unauthorized access to the plurality of hardware systems is executed.

5. The method of claim 4, wherein the unique sets of account numbers are stored in main memory in the plurality of hardware systems.

6. The method of claim 4, wherein the unique sets of account numbers are stored in logs in the memories in the plurality of hardware systems.

7. The method of claim 1, further comprising,
identifying, based on the plurality of account numbers, a subset of the plurality of hardware systems that may have been compromised; and
performing remediation on the subset of the plurality of hardware systems, wherein the first hardware system is part of the subset.

8. The method of claim 1, wherein the plurality of hardware systems comprises at least one of: point-of-sale (POS) systems, network devices, or payment servers.

9. The method of claim 8, wherein the plurality of hardware systems comprises the POS systems, wherein the POS systems are operated by the same payment network.

10. A computing system, comprising:
one or more memories; and
one or more processors communicatively coupled to the one or more memories, the one or more processors configured to, individually or collectively to perform operations, the operations comprising:
storing unique sets of account numbers in a plurality of hardware systems in a payment network, wherein each of the account numbers corresponds to a separate financial account;
determining that an account number for a first one of the unique set of account numbers stored in at least one of the plurality of hardware systems in the payment network is compromised;
receiving indications that each of the account numbers for the first one of the unique sets are compromised;
identifying a first one of the plurality of hardware systems in the payment network that comprises the compromised first one of the unique set of account numbers; and
causing a remediation operation to perform on the first one of the plurality of hardware systems in the payment network that comprises the compromised first one of the unique set of account numbers, wherein the remediation operation comprises:
isolating the first one of the plurality of hardware system from the remaining plurality of hardware systems in the payment network and deactivating the isolated first one of the plurality hardware systems from the payment network.

11. The computing system of claim 10, wherein each of the unique sets includes account numbers that are in other ones of the unique sets, but none of the unique sets have the same combination of account numbers.

12. The computing system of claim 10, further comprising:
receiving alerts from a financial institution that manages the separate financial accounts that the account numbers have been used to make attempted purchases.

13. The computing system of claim 10, wherein the unique sets of account numbers are planted in memories of the plurality of hardware systems and are intended to be discovered when unauthorized access to the plurality of hardware systems is executed.

14. The computing system of claim 10, wherein the operations further comprising,
identifying, based on the plurality of account numbers, a subset of the plurality of hardware systems that may have been compromised; and
performing remediation on the subset of the plurality of hardware systems, wherein the first hardware system is part of the subset.

15. The computing system of claim 10, wherein the plurality of hardware systems comprises POS systems, wherein the POS systems are operated by the same payment network.

16. A non-transitory computer-readable storage medium having computer-readable program code embodied therewith, the computer-readable program code executable by one or more computer processors to perform operations, the operations comprising:
storing unique sets of account numbers in a plurality of hardware systems in a payment network, wherein each of the account numbers corresponds to a separate financial account;
determining that an account number for a first one of the unique set of account numbers stored in at least one of the plurality of hardware systems in the payment network is compromised;
receiving indications that each of the account numbers for the first one of the unique sets are compromised;
identifying a first one of the plurality of hardware systems in the payment network that comprises the compromised first one of the unique set of account numbers; and
causing a remediation operation to perform on the first one of the plurality of hardware systems in the payment network that comprises the compromised first one of the unique set of account numbers, wherein the remediation operation comprises:
isolating the first one of the plurality of hardware system from the remaining plurality of hardware systems in the payment network and deactivating the isolated first one of the plurality hardware systems from the payment network.

17. The non-transitory computer-readable storage medium of claim 16, wherein each of the unique sets includes account numbers that are in other ones of the unique sets, but none of the unique sets have the same combination of account numbers.

18. The non-transitory computer-readable storage medium of claim 16, wherein receiving indications comprises:
receiving alerts from a financial institution that manages the accounts that the account numbers have been used to make attempted purchases.

19. The non-transitory computer-readable storage medium of claim 16, wherein the unique sets of account numbers are planted in memories of the plurality of hardware systems and are intended to be discovered when unauthorized access to the plurality of hardware systems is executed.

20. The non-transitory computer-readable storage medium of claim 16, wherein the operations further comprising,
identifying, based on the plurality of account numbers, a subset of the plurality of hardware systems that may have been compromised; and
performing remediation on the subset of the plurality of hardware systems, wherein the first hardware system is part of the subset.
